(19) United States
(12) Patent Application Publication
(10) Pub. No.: US 2015/0343546 A1
(43) Pub. Date: Dec. 3, 2015

(54) METHOD AND DEVICE FOR CLEANING A SOLDERING NOZZLE

(71) Applicant: SEHO SYSTEMTECHNIK GMBH, Kreuzwertheim (DE)

(72) Inventors: Thomas Herz, Kreuzwertheim (DE); Gerald Schmitt, Himmelstadt (DE); Reiner Zoch, Radeberg (DE); Markus Walter, Wertheim (DE)

(21) Appl. No.: 14/761,231

(22) PCT Filed: Dec. 13, 2013
(86) PCT No.: PCT/EP2013/076625

§ 371 Date: Jul. 15, 2015

(30) Foreign Application Priority Data
Jan. 17, 2013 (DE) 10 2013 100 473.3

(51) Int. Cl. B23K 3/08; B08B 3/12; B08B 7/02

(52) U.S. Cl. CPC B23K 3/08; B08B 7/028; B08B 3/12

(57) ABSTRACT

The present invention relates to a method and an apparatus for cleaning a solder nozzle, together with a soldering apparatus. In order to facilitate thorough and easy cleaning, impurities on the solder nozzle are removed by ultrasound from an ultra-sonic source.

The present invention relates to a method for cleaning a solder nozzle according to the preamble of claim 1, an apparatus for cleaning a solder nozzle according to the preamble of claim 8, and a soldering apparatus according to claim 15.

Already known from the prior art are examples of soldering apparatus which may be used to fix electronic components to printed circuit boards. The basic structure of such soldering apparatus is known for example from DE 84 08 427 U1. The soldering apparatus described there has a container in which liquid solder is held. Provided inside the container is a solder pressure chamber, on which is mounted an upwards-directed nozzle. In use according to the instructions, liquid solder is pumped into the solder pressure chamber by means of a pump. Due to the through flow and excess pressure arising there, the liquid solder flows through the nozzle and emerges at its upper end. The emerging solder then flows over the outside of the nozzle and back into the container. This gives rise to a solder wave, in which a connection to be soldered is dipped, by which means it is wetted with solder and soldered by subsequent cooling.

Also known from the prior art are examples of apparatus for ultrasonic soldering.

Described in D1 (DE 32 18 338 A1) are a soldering method and a soldering apparatus. Here it is provided that liquid flux and/or soldering means located in the area of the parts to be connected are also set in vibration by means of ultrasound. In accordance with this apparatus, the solder flows in a reverse wave on to a curved metal sheet (wave former), against the direction of conveyance of the in-fed printed circuit board. Provision may also be made for the solder wave to flow in two directions. Provided beneath the metal sheet in the area of the printed circuit board is an ultrasonic source. Therefore, primarily the wave former is subjected to the ultrasonic waves. By means of the ultrasonic source, the curved metal sheet and therefore the liquid tin flowing on it should be set in vibration such that, on soldering of the electrical connections of the components to the conductors of the printed circuit boards, good cleaning and wetting occurs. This should avoid the occurrence of cold soldering points.

DE 44 32 402 A1 discloses an apparatus for flux-free soldering using ultrasound. According to to this apparatus, it is provided that printed circuit boards are guided over the solder wave of a wave solder nozzle, wherein the soldering means are set into vibration by at least one ultrasonic electrode (sonotrode). This involves the surface of the sonotrode being covered directly by the solder wave and the printed circuit boards being guided closely above the surface of the sonotrode. The sonotrode is a part of the wave former and of the guide plate. The ultrasonic vibrations of the sonotrode should ensure good cleaning and wetting of the surfaces of the parts to be soldered. Because of this, pre-treatment of the parts to be soldered using flux should no longer be necessary. According to one embodiment, a mini wave is provided for area by area soldering of flat assemblies. Provided in a solder container is a sonotrode, which is part of a ring nozzle. The sonotrode and the ring nozzle are provided with a vertical bore and a horizontal connection bore, to which a pump is connected. By means of the pump, solder may be pumped from the solder container over the sonotrode to the nozzle, so that a solder wave forms at the solder outlet orifice of the bore. The solder outlet orifice is located centrally within the ring nozzle, wherein its angular or circular-arc-shaped edge area forms the guide surface for the solder flow to build up the solder wave. According to this embodiment, a nozzle which is in direct contact with the sonotrode and the solder flowing therein are set into vibration.

There are considerable reservations regarding the possibility of integrating a sonotrode in the body of a mini wave solder nozzle covered by liquid solder, since this involves temperatures which known compact sonotrodes are unable to withstand in the long-term. Moreover, it is not possible for the sonotrode to be located outside the solder bath and coupled to the mini wave solder nozzle, since the sound waves are transmitted not only to the mini wave solder nozzle, but also to the entire solder bath. A targeted application of sound to the soldering area is not possible.

JP H08-31 703 A discloses an ultrasonic soldering apparatus (see title). According to to this apparatus, the use of ultrasonic waves should improve the quality of soldering, and also make it possible to dispense with the use of flux. Here the ultrasonic source extends into the molten solder. Provision is made for subjecting the part to be soldered to ultrasonic waves, and for removing air bubbles, grease and oils by means of cavitation. The ultrasonic waves are also said to remove any oxide layer, thereby enhancing the quality of the soldered connection.

JP H06-315 765 A discloses a soldering apparatus with an ultrasonic source for ultrasonic soldering. Here it is provided that a part to be soldered is arranged in the solder bath of a solder nozzle. On one side of the part to be soldered in the solder bath is the ultrasonic source, and mounted opposite the ultrasonic source is a reflector. The distance from the ultrasonic source to the reflector should correspond roughly to the wavelength of the ultrasonic waves used. In this way, the part to be soldered should be well arranged in the range of the maximum amplitude of the wave. The reflector is intended to reduce energy consumption during ultrasonic soldering.

The types of apparatus disclosed in JP H08-31 703 A and JP H06-315 765 A are not suitable for selective soldering since, with these types of apparatus, due to the structure of the ultrasonic devices and the soldering unit, movement of a printed circuit board over these types of apparatus, and also movement of the apparatus towards a printed circuit board are not possible. In addition, ultrasonic generators may not be positioned at any desired distance from the unit(s), since the ultrasound cannot be transmitted over any desired length.

In JP S54/148137 A, the aim is for ultrasonic waves to be used to set a solder flow into vibration, so that the surface between the object to be soldered and the solder is activated, in order to dispense with the use of flux.

In the specialist book “Soft Soldering in Electrical Engineering” by R. J. Klein, second edition, Leuze Verlag, pages 94 to 96, the soft soldering of aluminum parts is described as the sole important application of ultrasonic soldering. It also states here that “ultrasonic soldering is not possible on a bath or a wave, since the mass of the printed circuit boards is not suitable for generating cavitation (at acceptable amplitudes and vibrations)”.

The prior art described above discloses types of ultrasonic soldering apparatus in which the vibrations generated by means of ultrasound are meant to effect an acceleration of the liquid, which then separates (cavitation) locally. In particular the parts to be soldered are here subjected to ultrasonic waves which are transmitted via the solder. Using such apparatus it should be possible to dispense with the use of flux, but in practice this has never been achieved. This is described in the specialist book “Soft Soldering in Electrical Engineering” by R. J. Klein.

Also known from the prior art are nozzles in which the solder does not run away over the outside of the nozzle. Provided in these nozzles is an insert, for example in the form of a metal tongue, which divides the interior of the nozzle. When used as instructed, the solder is conveyed through one part of the interior of the nozzle, leaves the nozzle at its upper end, and flows over the insert into the second part of the interior, from where it may be guided away.

There are also types of soldering apparatus which do not use a pump. In these soldering machines, a solder punch of the solder nozzle tips into a solder bath, at the same time taking up a certain amount of solder on its upper side in a type of well. The solder nozzle is then moved to the point to be soldered, wherein the point to be soldered is dipped into the well so that it is wetted with solder and in this way is finally soldered.

All types of nozzle may be at least partly tin-plated, since the solder runs preferably on tin-plated surfaces, and in this way the solder may be kept away from other surfaces. In the case of a nozzle with an insert, the latter is tin-plated, so that the solder runs along it. In the case of nozzles with no insert, the outer surface is at least partly tin-plated.

A problem which occurs in the operation of such soldering apparatus is the formation of so-called skimmings. These skimmings generally consist of flux residues and oxides washed off the items for soldering, which form on contact of the solder with atmospheric oxygen. It has already been described in DE 84 08 427 U1 that the nozzles must be cleaned from time to time, in order to ensure a continuous flow of solder. In this publication it is proposed that the nozzle is cleaned from time to time mechanically using a needle, which may be guided in and out of the nozzle. However, such cleaning devices do not adequately remove the skimmings and may also damage the nozzle. Also known is the cleaning of nozzles from the outside using brushes.

One possible means of reducing the formation of skimmings is the use of so-called activators. Known from EP 0 536 472 B1 is a solder piston in which carboxylic acids are used as activators. Mixed with the activators is a protective gas which flows around the solder point and is intended to prevent the forming of skimmings at the soldering point and the surrounding areas, and also to remove existing skimmings. The disadvantage of this method is, in particular, that additional substances, namely the activators, need to be used. These substances may mix with the solder, which can affect the quality of the solder points. The activators may also contaminate the solder bath of a soldering apparatus in which the solder circulates. Finally, despite the use of activators, the formation of skimmings may not be avoided completely.

DE 20 2009 002 666 U1 discloses a device for the cleaning and/or activation of solder nozzles using a cleaning and/or activation agent, wherein the cleaning and/or activation agent is fed automatically to the solder nozzle by a control unit.

It is therefore a problem of the invention to provide a method for the cleaning of a solder nozzle in which skimmings are removed as far as possible.

A further problem of the invention is to provide a method for the cleaning of a solder nozzle which has the least possible effect on operation of the solder nozzle.

These problems are solved by a method according to claim 1.

It is a further problem of the invention to provide an apparatus for cleaning a solder nozzle which makes possible the most complete cleaning of the solder nozzle in the simplest possible manner.

It is a further problem of the invention to provide an apparatus for cleaning a solder nozzle which, when incorporated and used in a soldering apparatus, interferes as little as possible with the ongoing operation of the soldering apparatus.

These problems are solved by an apparatus for cleaning a solder nozzle according to claim 8.

A further problem of the invention is to provide a soldering apparatus which allows the most continuous possible operation.

This problem is solved by a soldering apparatus according to claim 15.

Advantageous developments are the subject of the respective dependent claims.

The method according to the invention for the cleaning of a solder nozzle, in particular an at least partly tin-plated solder nozzle, is characterised in that sound of any desired frequency of a sound source is used to remove impurities , in particular undesired oxides, from the solder nozzle. It has become apparent that the cleaning of solder nozzles by means of sound is especially suitable for completely freeing a solder nozzle of undesired impurities. An especially advantageous feature of this is that the material of the solder nozzle itself is not damaged. Only the impurities on the surface of the nozzle are detached by the sound, and the nozzle is once again fully functional.

The method according to the invention and an apparatus according to the invention are designed in particular for selective soldering. In selective soldering, liquid solder flows through a mini wave solder nozzle movable relative to the assembly, and discharges at its upper end. The emerging solder then flows back into a solder bath over an outer side of the nozzle. This creates a solder wave, in which are dipped individual areas or points of an assembly connection to be soldered, which are thus wetted with solder and soldered by subsequent cooling.

In the context of the present invention, a sound source is understood as being a sound source for generating frequencies of 16 Hz to 300 kHz, and thus for generating sound and/or ultrasound.

In particular a sound source for generating frequencies of at least 100 Hz or 300 Hz or 600 Hz or 900 Hz or 1 kHz or 5 kHz or 10 kHz or 20 kHz or 25 kHz or 30 kHz or 35 kHz to 40 kHz or 45 kHz or 50 kHz or 55 kHz or 60 kHz and preferably of 35 kHz is used.

In this frequency range cavitation, by means of which cleaning of the nozzle surface is effected, takes place.

For cleaning, the sound source is brought close to the impurities. Here it is especially advantageous if the sound source is brought into contact with liquid solder, in particular a solder wave, which is formed at one end of the solder nozzle. The sound spreads out much better in the liquid solder, leading to distinctly more thorough and more complete cleaning.

A sound source for the purposes of the present invention is a device for the generation of audible sound and/or ultrasound, preferably one or more piezo elements, such as e.g. piezoelectric quartz or ceramic vibrators, or an ultrasonic source such as e.g.

a piezoceramic element, or a coil. The term “sound” is to be understood as meaning both audible sound and ultrasound.

With the method according to the invention it is no longer necessary to feed cleaning and/or activation agents to the solder nozzle. According to the prior art, these agents must be kept ready and metered as required. The invention on the other hand requires no consumable materials.

If the solder nozzle goes into operation, then cleaning takes place after bringing into operation, since the solder nozzles, in particular their tin-plated sections, oxidise and form skimmings after longer periods not in use.

When the solder nozzle is used according to instructions it is often the case that it is in continuous operation, i.e. there is constantly a solder wave.

In operation, incrustations due to burnt-in oxides and/or residues of flux occur on the surface of the solder nozzle, in particular on its outer surface.

However, not at every point in time does a connection to be soldered or an electronic component and a part of a printed circuit board or an assembly dip into the solder wave. This results in idle times in which the solder wave is not wetting a subsequent soldering point. These idle times may be used to carry out the cleaning. Since such idle times occur anyway during use of the solder nozzle as directed, cleaning of the solder nozzle by the method according to the invention does not lead to any delay in subsequent process steps. In this way, despite the additional cleaning step, the duration of the soldering process can be held constant.

A period of time between two or more cycles is also defined as an idle time phase.

The soldering of an assembly and the traversing to and fro of a solder nozzle is described as a cycle. Such a cycle normally lasts between 30 seconds and 10 minutes or between 1 minute and 6 minutes. Cleaning of the solder nozzle may be provided in particular after 5 to 20 cycles and preferably after every eight to fifteen cycles.

Due to the fact that there is provision for cleaning a solder nozzle after one or more cycles, the time-consuming and cost-intensive cleaning steps known from the prior art are dispensed with, and the soldering process is delayed only slightly by the necessary cleaning of a solder nozzle by means of the method according to the invention Moreover, soldering may be carried out permanently with a solder nozzle producing clean and thus fault-free soldered areas and points.

Preferably a solder nozzle is cleaned by sound or ultrasound for around 3 seconds to 1.5 minutes, or for 5 seconds to 45 seconds and in particular for 10 seconds to 30 seconds.

Such a process may be fully automated and requires no optical follow-up check of the solder nozzle.

In a further advantageous development of the method according to the invention, the sound source is introduced into at least one orifice of the solder nozzle. In particular in the case of solder nozzles with an insert, impurities occur not only at the upper-most edge of the solder nozzle or the insert, but also in lower-lying regions. Through the introduction of the sound source into an orifice of the solder nozzle, these impurities too are reliably removed. At the same time, the constant flow of solder through the solder nozzle ensures that the impurities are carried away.

So that nozzles with a more complex design may also be ensured complete cleaning it is provided in an advantageous development of the method according to the invention that the sound source is moved within at least one orifice of the solder nozzle and/or along at least one edge and/or one insert of the solder nozzle. If the solder nozzle is provided for example with a longer orifice, then the sound source may be introduced into one end of the orifice and then moved along the longitudinal extent of the nozzle. By this means, impurities are removed from all areas of the orifice. In the case of nozzles where the solder runs away on the outside, it is possible for example for a sound source to be run down the outer surface, maintaining a small clearance, so that in a simple manner and with minimal use of material, the entire outer surface of the nozzle may be freed from impurities.

Especially preferred is for the method according to the invention to use sound in the range from 30 kHz to 40 kHz, in particular 35 kHz. These frequency ranges have turned out to be especially advantageous for the cleaning of solder nozzles. At such a frequency it is advantageous that little oxygen settles in the solder during passage through the solder, and therefore little oxidation takes place.

Especially preferred is for the method according to the invention to use ultrasound in the range from 15 kHz to 2 MHz, in particular 20 kHz to 300 kHz. These frequency ranges have proven to be especially advantageous for the cleaning of solder nozzles.

The apparatus according to the invention for cleaning a solder nozzle, in particular an at least partly tin-plated solder nozzle, is characterised in that in particular at least one sound source is provided.

The apparatus for the cleaning of a solder nozzle is provided for use in a soldering apparatus and is also described below as a cleaning device. Through the ultrasonic source of the apparatus according to the invention, effective and thorough cleaning of a solder nozzle is possible.

The sound source has preferably a sound generator and a sound guiding device. Here the sound generator is responsible for the actual generation of the sound, while the sound guiding device guides the sound from the sound generator to the solder wave or solder nozzle. The sound generator may therefore be arranged at some distance from the solder nozzle, which is advantageous, since sound generators in general are susceptible to higher temperatures, such as occur with solder nozzles.

The ultrasonic source has preferably an ultrasonic generator and an ultrasonic guiding device. Here the ultrasonic generator is responsible for the actual generation of the ultrasound, while the ultrasonic guiding device guides the sound from the ultrasonic generator to the solder wave or solder nozzle. The ultrasonic generator may therefore be arranged at some distance from the solder nozzle, which is advantageous, since ultrasonic generators in general are susceptible to higher temperatures, such as occur with solder nozzles.

The sound or ultrasonic guiding device may be tubular, since ultrasound is well guided by the tubular form. At one end of the sound or ultrasonic guiding device is the sound or ultrasonic generator, while the other end may be dipped into the solder wave. Alternatively, the ultrasonic guiding device may also guide the sound or ultra-sound by means of a rod-like body. Even in solid bodies, the sound or ultrasound is able to spread out well. The rod-like body may then similarly be held in the solder wave or directly on the solder nozzle, so that the impurities are detached.

In an advantageous development of the apparatus according to the invention for cleaning a solder nozzle, the sound or ultrasound source may be moved between several positions, wherein the sound or ultrasound source in a first cleaning position is able to touch the solder wave, and in a second standby position does not touch the solder wave.

A movement device is provided for effecting movement.

In this way, the apparatus according to the invention may be incorporated in the on-going operation of the solder nozzle. If the solder nozzle, in particular dipped into the solder wave, is occupied by an assembly or connection ready for soldering, then the ultrasonic source is in the standby position. In this position it does not obstruct the assembly, so that the soldering process, as known from the prior art, may be completed. If now the assembly is no longer in the area of the solder nozzle, then the ultrasonic source may be brought into the first cleaning position, in which it frees the solder nozzle of impurities. These idle times, in which therefore no assembly is to be soldered, may be used fully by the apparatus for cleaning the solder nozzle. Shortly before the next assembly reaches the area of the solder nozzle, the apparatus according to the invention is moved back into the standby position, so that the next assembly too may be soldered as usual and without delay.

The ultrasonic source may also be stationary. Then the solder nozzle or the selective soldering device is moved by the movement device to the sound or ultrasonic source for cleaning.

Alternatively, the ultrasonic source may also be stationary. Then the solder nozzle and if necessary the solder bath is or are moved around the ultrasonic source for cleaning.

In an advantageous development of the apparatus according to the invention, the latter has a cap-shaped element, in which the sound or ultrasonic source is located. The cap-shaped element is at the same time advantageously so designed that it leans against the outer shape of the nozzle with minimal clearance. To clean the solder nozzle, the cap-shaped element is put over the solder nozzle. As a result, the cap-shaped element and the external geometry of the solder nozzle form an space in which the sound or ultrasound may spread out more easily, thereby ensuring thorough cleaning of the solder nozzle. The sound is transmitted through the solder found in the intermediate space.

Also regarded as especially advantageous in the context of the invention is the provision of several sound or ultrasonic sources. This makes possible the simultaneous cleaning of several areas of the solder nozzle. For a nozzle with an insert, an apparatus with two sound or ultrasonic sources is especially suitable, wherein in each case one sound or ultrasonic source is inserted in each of the two sub-orifices of the nozzle which are separated by the insert. The use of several sound or ultrasonic sources is also advantageous in combination with the cap-shaped element, since in this way the entire outer surface of the nozzle may be cleaned, without the need for movement of the cap-shaped element. Nevertheless, the apparatus may even then execute a movement, if a multiplicity of sound or ultrasonic sources is provided. In this case the multiplicity of sound or ultrasonic sources serve to reduce cleaning time.

In order to facilitate thorough cleaning even inside the orifice of a solder nozzle, an advantageous development of the apparatus according to the invention for the cleaning of a solder nozzle provides that the apparatus according to the invention has at least one bar-shaped element or is in the form of a bar-shaped element, with the sound or ultrasonic source located on the bar-shaped element. This makes it possible to clean lower-lying regions of a solder nozzle too. The bar-shaped element may then be inserted in an orifice of the solder nozzle and clean the lower-lying areas.

So that solder nozzles with several orifices may also be cleaned thoroughly and in an acceptable period of time, an advantageous development of the apparatus according to the invention provides for the apparatus to have a fork-shaped area. This form of development is suitable in particular for solder nozzles with several orifices running parallel to one another. It is especially advantageous when the fork-shaped area has several prongs, with an ultrasonic source fitted to at least two prongs. Here, the fork-shaped area may be so designed that one prong dips into one orifice of the solder nozzle, and another prong into a further orifice of the solder nozzle, so that a prong with a sound or ultrasonic source is to be found in both orifices simultaneously. In this way, both orifices may be cleaned at the same time. If more than two prongs are provided, then it is also possible to provide the further prongs with sound or ultrasonic sources. Preferably there is a sound or ultrasonic source on each prong.

Preferably, the ultrasonic source of the apparatus according to the invention generates ultrasound in the range of 15 kHz to 2 MHz, in particular 20 kHz to 300 kHz. These frequency ranges are especially advantageous for the cleaning of solder nozzles.

According to one development of the present invention, a spray protection fixture is provided to conduct away sprayed-around solder during cleaning of the solder nozzle. The spray protection fixture is in the form of a tubular body, so that it encompasses the sound or ultrasonic source during cleaning with minimal clearance. The sound or ultrasonic source preferably generates a standing wave. In the area of the zero crossing of the standing wave there are no or only minimal vibrations. The spray protection fixture is therefore preferably attached to the ultrasonic guiding device in the area of the zero crossing, so that it does not vibrate and therefore does not become loose. The spray protection fixture may also be fixed above the sonotrode.

Sprayed-around solder sprays during cleaning against an internal lining wall of the tubular body and from there runs down under gravity into the solder or into a solder bath, e.g. the solder bath provided with a nozzle for selective soldering, for receiving solder running down over the outer surface of the nozzle. The tubular body is preferably an elastic glass fibre tube, which may be pulled over the sound or ultrasonic source in such a way that it extends beyond the latter by around 2 mm to 2.5 mm or 5 mm to 1.5 cm and in particular 7 mm to 1 cm. This end of the spray protection fixture may be designed, due to the elastic nature of the tube, to taper conically towards the solder nozzle. Other suitable materials, which facilitate the draining away of solder, are also conceivable.

The spray protection fixture may also be made of another suitable solder-draining or even solder-absorbing material.

It is also possible for the spray protection fixture to be of rigid design.

The soldering apparatus according to the invention has at least one solder nozzle and at least one apparatus for the cleaning of a solder nozzle according to the above descriptions. Preferably, as well, the ultrasonic source of the apparatus for cleaning a solder nozzle may be introduced into at least one orifice of the solder nozzle and/or encompasses the latter with a cap-shaped element.

Preferably the number of sound or ultrasonic sources and the geometry of the cleaning apparatus are matched to the available nozzles. Also, in a soldering apparatus with several solder nozzles, a central cleaning apparatus may be provided, which is so designed that it may be used for cleaning all solder nozzles. Alternatively, several cleaning units may be provided, in particular a specially adapted cleaning apparatus for each solder nozzle or each type of solder nozzle. For the soldering apparatus of DE 102 15 963 A1, for example, two types of cleaning apparatus could be provided, one for the tubular solder nozzles and another for the elongated solder nozzles.

Preferably the soldering apparatus according to the invention is a wave soldering machine, in particular a mini wave soldering machine and/or a multi-wave and/or a selective soldering machine, or a soldering apparatus with one or more solder nozzles in the form of a solder punch.

Especially advantageous is the cleaning apparatus for a selective soldering machine with a solder nozzle, in which the printed circuit board and the solder nozzle are moved relative to one another and controlled by a coordinate system. In the case of such a soldering apparatus, the individual nozzle may be cleaned just by means of a single cleaning apparatus, which again is especially economical.

The invention is shown and explained below by way of example with the aid of nine Figures, showing in:

FIG. 1: a solder nozzle with a first embodiment of the apparatus according to the invention for cleaning a solder nozzle

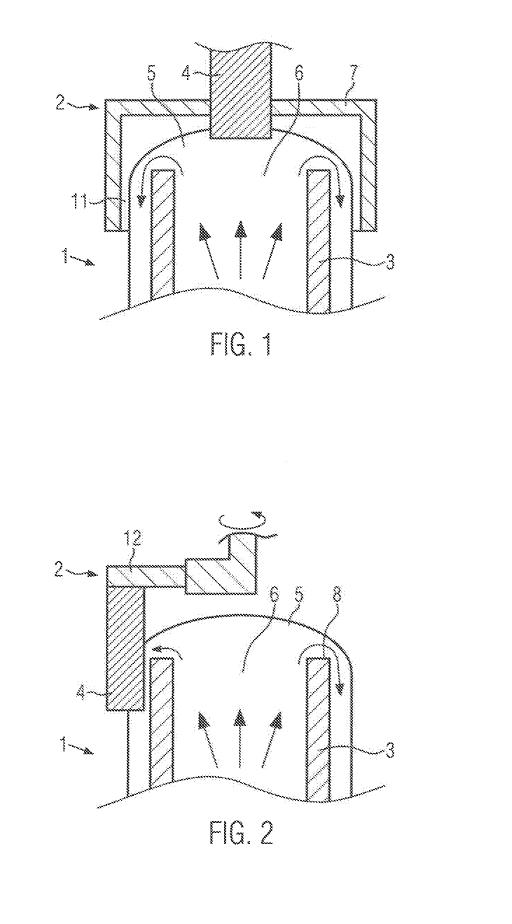

FIG. 2: the solder nozzle of FIG. 1 with a further embodiment of the apparatus according to the invention for cleaning a solder nozzle

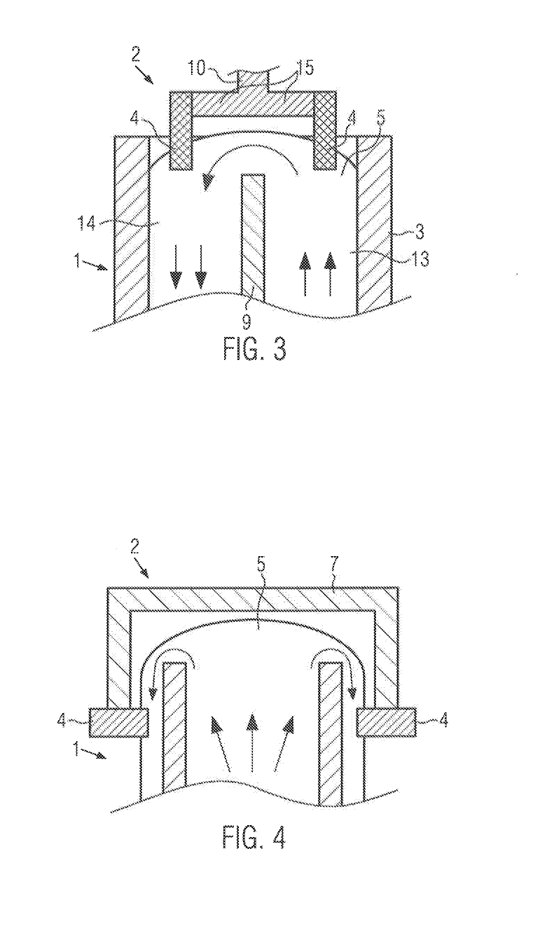

FIG. 3: a solder nozzle with insert and a further embodiment of the apparatus according to the invention for cleaning a solder nozzle

FIG. 4: the solder nozzle of FIG. 1 with a further embodiment of the apparatus according to the invention for cleaning a solder nozzle

FIG. 5: a further embodiment of an apparatus according to the invention for cleaning a solder nozzle

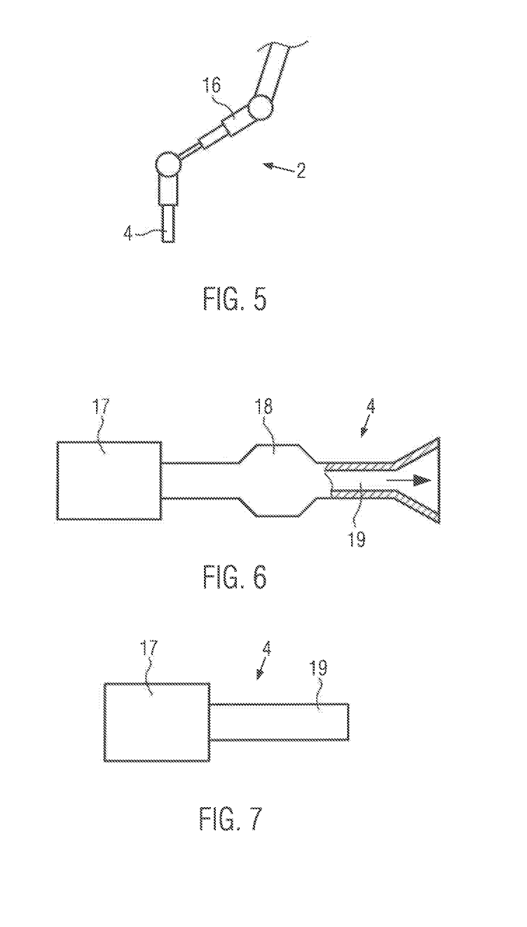

FIG. 6: an embodiment of an ultrasonic source for a cleaning apparatus according to the invention

FIG. 7: a further embodiment of an ultrasonic source for a cleaning apparatus according to the invention

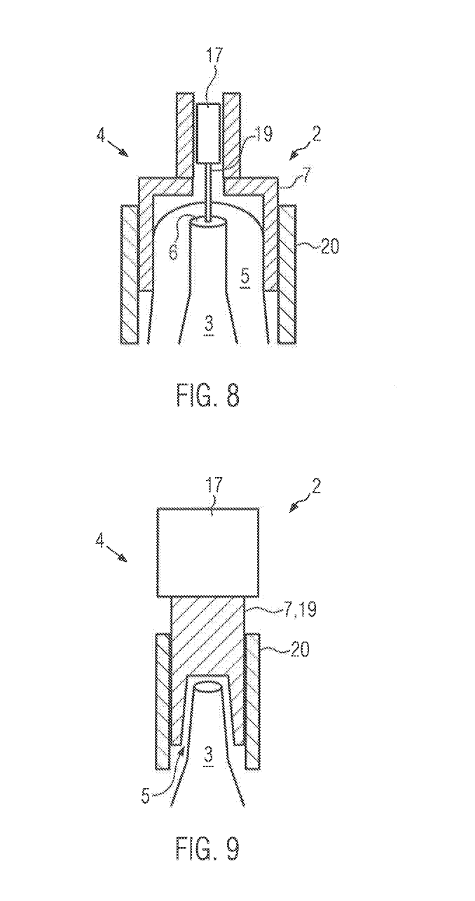

FIG. 8: a further embodiment of an apparatus according to the invention for cleaning a solder nozzle

FIG. 9: a further embodiment of an apparatus according to the invention for cleaning a solder nozzle

The solder nozzle 3 of a soldering apparatus 1 shown in FIG. 1 in a longitudinal section has a tubular cross-section. Inside the solder nozzle 3 is liquid solder, which is conveyed by other parts of a soldering apparatus (not shown) through the solder nozzle 3 and emerges at its upper end through an orifice 6. This creates a solder wave 5 of liquid solder, into which an assembly or a connection to be soldered may be dipped so that it is wetted and in this way soldered.

At the upper end of the solder nozzle 3, an apparatus for cleaning a solder nozzle (hereafter cleaning apparatus 2) is or may be provided. The cleaning apparatus 2 has a cap-shaped element 7 which is matched to the shape of the solder nozzle 3 and therefore likewise has a tubular cross-section, with the inside diameter being slightly larger than the outside diameter of the solder nozzle 3.

Located in the central zone of the cap-shaped element 7 is an ultrasonic source 4.

The cap-shaped element may be in the form of an ultrasonic guiding device, which is part of the ultrasonic source.

To implement the method according to the invention, the ultrasonic source 4 is switched on, so that it emits ultrasound. The ultrasonic source 4 is at the same time in contact with the solder wave 5. The ultrasound is able to spread out in the space 11 formed between the cap-shaped element 7 and the solder nozzle 3, and especially in the solder wave 5. In this way, the ultrasound reaches impurities, which are present in particular on the outer surface of the solder nozzle 3, and detaches them from the solder nozzle 3. The impurities are carried off by the continuous flow of solder so that, on completion of the cleaning process, they no longer adhere to the solder nozzle 3.

Shown in FIG. 2 is a further embodiment of the cleaning apparatus 2 according to the invention, in which no cap-shaped element is provided. Here the cleaning apparatus 2 consists of an arm 12, at the end of which is provided an ultrasonic source 4. The ultrasonic source 4 is at the same time, starting from the arm 12, aligned on to the outer surface of the solder nozzle 3. The arm 12 is mounted rotatably around an axis which corresponds to the central axis of the solder nozzle 3. If the arm 12 is rotated around this axis of rotation, then the ultrasonic source 4 gradually covers the entire periphery of the solder nozzle 3. The arm 12 is telescopic and thus adaptable to solder nozzles with different diameters.

In this embodiment of the cleaning apparatus 2 according to the invention, the ultra-sonic source 4 similarly dips into the solder wave 5. This leads to an especially thorough cleaning, since the ultrasonic waves of the ultrasonic source 4 are able to spread out especially well in the liquid solder.

The solder nozzle 3 shown in FIG. 3 is a solder nozzle with an insert 9. In the case of this solder nozzle 3, the liquid solder does not flow away on the outer surface of the solder nozzle 3, but instead flows from a first sub-chamber 13 into a second subchamber 14. The two sub-chambers 13, 14 are separated by the insert 9. This gives rise to a solder wave 5 which jumps from the first sub-chamber 13 over the insert 9 into the second sub-chamber 14. The insert 9 in such nozzles is generally tin-plated.

Although it would in principle be possible to clean such nozzles too with only one ultrasonic source 4, by introducing this first into the first sub-chamber 13 and then into the second sub-chamber 14, in the embodiment of the cleaning apparatus 2 according to the invention shown in FIG. 3 there is provided a fork-shaped area 10, at which the apparatus 2 divides into several prongs 15. In the depicted embodiment these are two prongs 15, with an ultrasonic source 4 provided on each of the two prongs. The one ultrasonic source 4 is introduced into the first sub-chamber 13, and the second ultrasonic source 4 into the second sub-chamber 14. In this way, both ultrasonic sources 4 are in contact with the solder wave 5. By this means, impurities in the first sub-chamber 13 and in the second sub-chamber 14 may be detached simultaneously.

In accordance with an embodiment which is not shown but is similar to that shown in FIG. 3, the solder nozzle may have tin-plated inserts with several first sub-chambers, wherein the insert 9 as described above according to this embodiment forms an overflow edge.

Also in the case of solder nozzles with tin-plated inserts, these may therefore be cleaned on both sides or simultaneously.

In the embodiment according to FIG. 4 of the cleaning apparatus 2 according to the invention, two ultrasonic sources 4 are also provided. The cleaning apparatus 2 has a cap-shaped element 7 which is pulled over the solder nozzle 3. Since with this type of solder nozzle 3, it is primarily the outsides which must be cleaned, the ultrasonic sources 4 are so arranged that they make contact with the solder wave 5 in the area of the outer surface of the solder nozzle 3. In this way, the outer surface is thoroughly cleaned.

FIG. 5 shows an embodiment of the cleaning apparatus 2 according to the invention, which may be used to clean solder nozzles of different shapes. The cleaning apparatus 2 has a manipulator arm 16, on the end of which is provided an ultrasonic source 4. The ultrasonic source 4 may be firmly mounted on the manipulator arm 16. Alternatively, the manipulator arm 16 may be equipped with a gripper (not shown), with which an ultrasonic source 4 may be alternately taken up and placed down. Since the manipulator arm 16 is able to move freely in space and may be suitably programmed, it is possible for the manipulator arm 16 to pass over different solder nozzles and in each case dip the ultrasonic source 4 into the solder wave. In this way, thorough cleaning of different types of solder nozzles is possible.

FIG. 6 shows an embodiment of an ultrasonic source 4 for the cleaning apparatus according to the invention. The ultrasonic source 4 has at one end an ultrasonic generator 17 which generates ultrasound. After generation, the ultrasound passes into an ultrasonic amplifier 18, which amplifies the ultrasound. The ultrasound is then fed through a tubular ultrasonic guiding device 19 in the direction shown by the arrow so as to exit, thereby concentrated, at the expanding end of the ultrasonic source 4. This end, when used as directed, is brought into contact with the solder nozzle or the solder wave, by which means the ultrasound spreads out further in the solder wave or the solder nozzle.

FIG. 7 shows an alternative design of the ultrasonic source 4 in which the ultrasonic guiding device is rod-shaped, i.e. made of solid material. The ultrasound is transmitted directly from the ultrasonic generator 17 to the ultrasonic guiding device 19 where it spreads out. The free end of the ultrasonic guiding device 19 may then, in use as directed, be brought into contact with the solder wave or the solder nozzle.

Instead of the ultrasonic source, according to the invention a sound source may also be provided.

Also provided according to the invention is a soldering apparatus 1 (FIG. 9). The soldering apparatus 1 includes at least one solder nozzle 3 and at least one apparatus 2 for cleaning a solder nozzle.

The apparatus 2 for cleaning a solder nozzle includes an ultrasonic source 4 with an ultrasonic generator 17, on which is provided an ultrasonic guiding device 19. The ultrasonic source 4 may also have an ultrasonic amplifier (not shown). The ultrasonic guiding device 19 is in the form of a cap-shaped element.

The solder nozzle 3 and the apparatus 2 for cleaning a solder nozzle may be moved relatively towards one another, by means of a movement device, in such a way that the solder nozzle 3 may be so arranged in the area below the apparatus 2 for the cleaning of a solder nozzle that a sound or ultrasonic guiding device 19 contacts the solder emerging from the solder nozzle , in particular a mini wave solder nozzle. In this way, the sound waves emitted by the sound or ultrasonic source may be transmitted over the solder towards the nozzle 3, in particular to the outer surface of a solder nozzle for selective soldering.

Also provided according to the invention is a soldering apparatus 1 (FIG. 8). The soldering apparatus 1 includes at least one solder nozzle 3 and at least one apparatus 2 for cleaning a solder nozzle.

The apparatus 2 for cleaning a solder nozzle comprises an ultrasonic source 4 with an ultrasonic generator 17 on which is mounted an ultrasonic guiding device 19. The ultrasonic source 4 may also have an ultrasonic amplifier 18 (not shown). The ultrasonic guiding device 19 is in the form of a bar-shaped element. The ultrasonic guiding device 19 is surrounded by a cap-shaped element 7.

In the present embodiment, the apparatus 2 for cleaning a solder nozzle is immovable. A traversing device of the wave soldering machine with solder bath may be used for relative movement of the solder nozzle, so that the latter is located as described above.

A reverse arrangement, in which the solder nozzle 3 is stationary and the apparatus 2 for cleaning a solder nozzle is movable, is also possible. Also, the solder nozzle 3 and the apparatus 2 for cleaning a solder nozzle may both be movable by means of the movement device.

The soldering apparatus is preferably a selective soldering apparatus with a mini wave solder nozzle.

According to a development of the present invention, a spray protection fixture 20 is provided to conduct away sprayed-around solder during cleaning of the solder nozzle

(FIG. 8). The spray protection fixture 20 is so designed as a hose- or tube-shaped that during cleaning it encompasses with minimum clearance the cleaning device, in particular the ultrasonic guiding device, especially when this is in the form of a cap-shaped element, or also the sound or ultrasonic source and the solder nozzle. During cleaning, sprayed-around solder sprays against an inner lining wall of the tubular body, and from there runs downwards due to gravity either into the liquid solder or into a separate collecting vessel. The tubular body 20 is preferably a glass-fibre tube. Other suitable materials, which have adequate heat resistance and facilitate the carrying away of solder, are also conceivable.

The sound or ultrasonic source preferably generates a standing wave. In the area of zero crossing of the standing wave there are no or only minimal vibrations. The spray protection fixture 20 is therefore preferably fixed to the ultrasonic guiding device 19 in the area of the zero crossing, so that the latter does not vibrate and does not therefore become loose. The spray protection fixture may also be fixed above the sonotrode.

The apparatus 2 for cleaning a solder nozzle may also be in the form of a hand-held device for manual cleaning of a solder nozzle, so that a solder nozzle is cleaned manually after a predetermined number of cycles. Such a hand-held device comprises at least one ultrasonic source 4 with an ultrasonic generator and an ultrasonic guiding device, together with an ultrasonic amplifier if required.

The cleaning apparatus according to the invention is especially preferred for use with selective soldering apparatus, since such soldering apparatus has individual solder nozzles, which are well cleaned by the cleaning apparatus according to the invention. In the case of wave soldering machines with a single large elongated solder wave, the cleaning apparatus according to the invention may still also be used, but cleaning takes up more time.

### LIST OF REFERENCES

1 soldering apparatus

2 cleaning apparatus

3 solder nozzle

4 ultrasonic source

5 solder wave

6 orifice

7 cap-shaped element

8 edge

9 insert

10 fork-shaped area

11 space

13 arm subchamber

13 first sub-chamber

14 second sub-chamber

15 prongs

16 manipulator arm

17 ultrasonic generator

18 ultrasonic amplifier

19 ultrasonic guiding device

20 spray protection fixture

1-18. (canceled)

19. A method for cleaning a solder nozzle comprising removing impurities from the solder nozzle during idle periods by sound from a sound source.

20. The method for cleaning the solder nozzle according to claim 19, wherein in the sound source is brought into contact with liquid solder.

21. The method for cleaning the solder nozzle according to claim 19, wherein the solder nozzle is brought into operation and the cleaning is effected on the solder nozzle for selective soldering.

22. The method for cleaning the solder nozzle according to claim 19, wherein the solder nozzle is cleaned by sound for a time of between about 3 seconds and about 90 seconds.

23. The method for cleaning the solder nozzle according to claim 19, wherein the sound from sound source is introduced into at least one orifice of the solder nozzle.

24. The method for cleaning the solder nozzle according to claim 19, wherein the sound source is moved in relation to one of the following: within at least one orifice of the solder nozzle, along at least one edge and along an insert of the solder nozzle.

25. The method for cleaning the solder nozzle according to claim 19, wherein the sound is in the range of between about 5 kHz and about 60 kHz.

26. An apparatus for cleaning a solder nozzle, comprising:
at least one sound source, and
a movement device, wherein said movement device can position the sound source in relation to the solder nozzle so that the solder nozzle may be cleaned, and can position the sound source sufficiently from the solder nozzle so that an assembly may be soldered.

27. The apparatus for cleaning a solder nozzle according to claim 26, wherein that the sound source or the solder nozzle can move relative to one another to more than one position by the movement device, wherein the sound source in a first cleaning position can contact a solder wave and in a first standby position does not contact the solder wave.

28. The apparatus for cleaning a solder nozzle according to claim 26, wherein said apparatus has a cap-shaped element that is part of a sonic guiding device, which is part of the sound source.

29. The apparatus for cleaning a solder nozzle according to claim 26, wherein the apparatus includes a bar-shaped element, wherein the sound source is mounted on the bar-shaped element.

30. The apparatus for cleaning a solder nozzle according to claim 26, wherein the apparatus includes a fork-shaped area.

31. The apparatus for cleaning a solder nozzle according to claim 30, wherein the fork-shaped area includes several prongs, with a sound source positioned on at least two prongs.

32. The apparatus for cleaning a solder nozzle according to claim 26 wherein the sound source can generate sound in the range of between about 5 kHz and about 60 kHz.

33. The apparatus for cleaning a solder nozzle according to claim 26, wherein the sound source includes a tube-shaped spray protection fixture for carrying away solder.

34. The apparatus for cleaning a solder nozzle according to claim 26 having at least one solder nozzle.

35. The apparatus for cleaning a solder nozzle according to claim 26 including the ultrasonic source that can be introduced into at least one orifice of the solder nozzle or encompasses the solder nozzle in a cap-like shape, so that sound emitted by the ultrasonic source is transmitted to the inner and/or outer surface of the solder nozzle.

36. The apparatus for cleaning a solder nozzle according to claim 26 includes one of the following: a wave soldering apparatus, a mini-wave soldering apparatus, a soldering apparatus multi-wave apparatus, a selective soldering apparatus and a punch soldering apparatus.
